(19) United States
(12) Patent Application Publication
(10) Pub. No.: US 2011/0231449 A1
(43) Pub. Date: Sep. 22, 2011

(54) System, Method, and Apparatus for Managing Patent Reference Reporting

(76) Inventors: William B. Ashley, Burnsville, MN (US); Tracey M. Dotter, Bloomington, MN (US)

(21) Appl. No.: 13/050,439

(22) Filed: Mar. 17, 2011

Related U.S. Application Data
(60) Provisional application No. 61/314,880, filed on Mar. 17, 2010.

(51) Int. Cl. G06F 17/30; G06F 7/00

(52) U.S. Cl. 707/800; 707/E17.048

(57) ABSTRACT

A reporting database establishes linkages between patent applications so that first references reported in a first patent application are indicated as needing to be reported in a second patent application. In one scenario, a similar second linkage is also established between the second patent application and a third patent application. In such a case, there may be no linkage between the first patent application and the third patent application analogous to the first and second linkages. When it is detected in such a case that the first references have been reported in the second patent application, an indication that the first references need to be reported in the third patent application may prevented based on determining that the first references did not originate from the second patent application.

### CROSS-REFERENCE TO RELATED APPLICATIONS

This application claims the benefit of provisional application No. 61/314,880, filed on Mar. 17, 2010 to which priority is claimed pursuant to 35 U.S.C. §119(e), and which is incorporated herein by reference in its entirety.

### TECHNICAL FIELD

The present disclosure relates to management of references reported during patent prosecution.

### BACKGROUND

In the United States, a patentee has a duty to disclose to the patent office any publications, patents, and other disclosures that may be material to patentability of a pending patent application. This may be accomplished by the filing of an Information Disclosure Statement (IDS) that lists relevant references, and may be accompanied by copies of some of the references (e.g., foreign patent documents, non-patent publications, etc.). Failure to disclose material information could lead to a finding of inequitable conduct, resulting in loss of all rights in the patent at issue. This may occur in the course of a lawsuit where infringement of the issued patent is alleged.

Patent practitioners (e.g., patent attorneys, patent agents) often handle numerous patent applications that have similarities to each other. For example, a corporation may file numerous patents related to a product currently in development before that product goes to market. A single practitioner may have a technical specialty related to the subject matter of those patents, and therefore may draft, file, and prosecute many of the related patents. Sometimes patents may be directly related, such as where one patent is a continuation of another, or where a patent is filed in another country that uses the same specification as and claims priority to a U.S. filed patent application. In other cases, two commonly owned patents may claim and describe different subject matter, but deal with similar technological areas/improvements, such that art cited in one case may also be relevant to the claims of the other case.

When handling related cases, practitioners need to consider that art cited by an examiner in one case may be relevant to another case that is being handled by a different examiner. In the past, disclosure to the examiners of the related cases was often considered sufficient to satisfy the duty of disclosure. However, a recent number of decisions in the Federal Courts have made it significantly easier to show inequitable conduct due to failure to cross-disclose art between related cases, even if the relationship between different applications has already been disclosed to the Patent Office. See, e.g., Dayco Prods., Inc. v. Total Containment, Inc., 329 F.3d 1358 (Fed. Cir. 2003), and McKesson Info. Solutions, Inc. v. Bridge Med., Inc., 487 F.3d).

These holdings strongly suggest that all of the “relevant” art cited in one case must now be disclosed in all other related cases, even when the patentees have previously informed the examiner of the existence of the related case. Further, courts have also held that communications from the patent office (e.g., Office Actions, Notices of Allowance) must also be disclosed between related cases. As result, both practitioners and patent examiners may significantly be increasing the time spent in dealing with IDS submissions.

While cross-citation of references between just two related cases may be manageable, some patentees have a large number of related cases. For example, one approach used by patentees is to file a large and detailed provisional application, e.g., to preserve a patent filing date for a product that will soon go public. Over the next year, the patentee may file a number of utility applications based on the provisional, each claiming a specific and somewhat different aspect of the provisional disclosure. In such a case, the patentee may feel obligated to cross-cite all art disclosed in all the utility cases. In some cases, this can lead to a nearly geometric increase in the number of references that are submitted to the patent office compared to applications that are not so related.

Both patent prosecutors and patent examiners are given a limited amount of time to spend on a given case. Accordingly, it is desirable to reduce the volume of IDS disclosures while still complying with the heightened standards for complying with duty of disclosure.

### SUMMARY

The present specification discloses systems, apparatuses, computer programs, data structures, and methods for managing patent reference submissions. In one embodiment, methods, systems, apparatuses, and computer-readable media may involve/perform/facilitate establishing a first linkage in a database between first and second patent applications so that first references reported in the first patent application are indicated as needing to be reported in the second patent application when data related to the second patent application is accessed via the database. A second linkage is established in the database between the second patent application and a third patent application so that second references reported in the second patent application are indicated as needing to be reported in the third patent application. There is no linkage in the database between the first patent application and the third patent application analogous to the first and second linkages. It is detected via the database that the first references have been reported in the second patent application. An indication that the first references need to be reported in the third patent application is prevented based on determining that the first references did not originate from the second patent application.

In some embodiments, at least the first linkage may be a subject matter relationship between the first and second patent applications. In other embodiments a non-zero hops value may be assigned to at least one of the first references when the first references are reported in the second patent application. In such a case, preventing the display of the at least one first references in the third patent application is based on the non-zero hops value.

In other embodiments, a zero hops value may be assigned to at least one of the first references when the first references are reported in the second patent application. In such a case, at least one of the first references is displayed as needing to be reported in the third patent application based on the zero hops value.

In one more particular example, the first and second references may include non-patent publications, and wherein identity between any two of the non-patent publications is determined based on comparison of character string identifiers formed based on the titles of the non-patent publications. In such a case, the string identifiers may be formed by capitalizing all letters of the respective titles and removing all non-numeric identifiers from the respective titles. Also in such a case, the character string identifiers may be further truncated to be no more than a predetermined length.

These and various other advantages and features are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments.

### BRIEF DESCRIPTION OF THE DRAWINGS

The invention is described in connection with example embodiments illustrated in the following diagrams.

FIG. 1 is a block diagram of case relationships which may be managed by example embodiments described herein;

FIG. 2 is a block diagram of additional case relationships to which may be managed by example embodiments described herein;

FIG. 3 is a block diagram of systems and apparatuses according to example embodiments;

FIG. 4A is a servlet diagram according to an example embodiment;

FIGS. 4B, 5-8, 9A-B, and 10 are user interface diagrams according to example embodiments;

FIGS. 11 and 12 are flowcharts illustrating procedures according to example embodiments; and

FIG. 13 is a database entity relation diagram according to an example embodiment.

### DETAILED DESCRIPTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the claimed subject matter.

The present disclosure generally relates to a computerized process for dealing with IDS submissions to the U.S. Patent Office. While the described embodiments may described in the context of tools for patent practitioners, it will be appreciated that the same features may be of use to patent offices, e.g., in dealing with large IDS submissions.

In the description hereinbelow, a terminology is employed to distinguish between documents that list potential prior art references, and the potential prior art references themselves. Thus, unless the context indicates differently, the term “document,” “submission document,” and the like is intended to indicate an IDS or listing from a patent office of references cited as relevant. Likewise, the term “reference” is intended to describe a patent, patent publication, non-patent publication, and the like that is being cited or considered as possible prior art relative to a patent application.

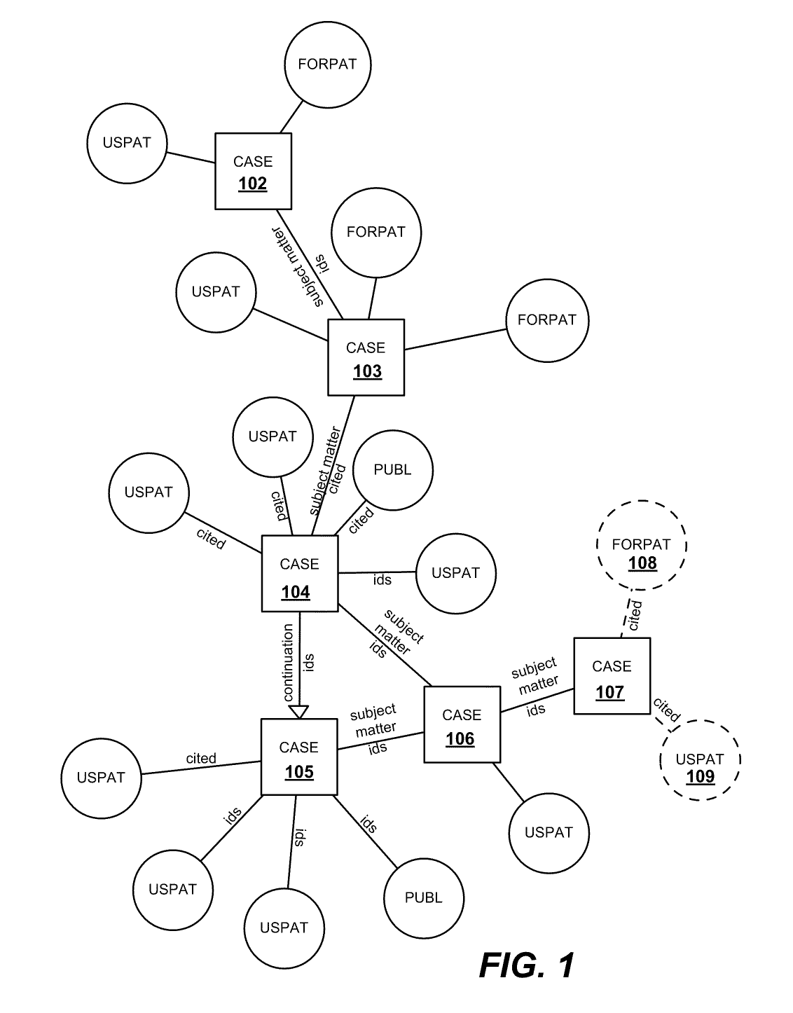

In reference now to FIG. 1, a block diagram illustrates a relationship between patent applications to which the disclosed embodiments may be applied. In this example, six patent applications 102-107 may be simultaneously pending and being managed by a common entity. Lines linking the cases 102-107 indicate the relationship between the cases and how it was determined that the cases are related. In the present disclosure, the term “subject matter” related generally means that there is at least some related subject matter expressly or impliedly disclosed in the related cases. This determination can be made at a broad level (e.g., based purely on the specification) or at finer granularity (e.g., based on current state of the claims in the target case). How and why a subject matter relation may be determined, while of practical significance, need not be considered further to understand the presently discussed concepts.

A different type of relation is seen between cases 104 and 105, where case 105 is a continuation of case 104. This may be a straight continuation, continuation-in-part, etc. Generally the continued case 105 may include at least the entire disclosure of case 104 and share a priority date and common inventorship with case 104. The continuation relation is generally considered a stronger relation than a subject matter relation, at least in relation to the concepts discussed further herein.

As mentioned above, the lines connecting cases also indicate how this relationship was determined. Most of the illustrated cases were reported to the patent office by the applicant, as indicated by the term “ids.” However, sometimes one case being managed by a practitioner may be cited by an examiner in another case being managed by that practitioner. This is indicated by the term “cited,” as seen in the linkage between cases 103 and 104.

Also shown in FIG. 1 are circles indicating references that are being either cited by an examiner or reported by the applicant as possibly being material to patentability. These are annotated here with the term USPAT indicating U.S. patents and patent publications, FORPAT indicating non-U.S. patents and patent publications, and PUBL indicating non-patent publications. Similar to the related cases, the lines connecting a case to a reference indicates how it was determined that the reference was relevant. The term “ids” indicates the applicant submitted the art, and “cited” indicating that a patent examiner cited the case, e.g., in an Office Action.

Two of the references, 108 and 109, are shown in broken lines, indicating that these references have just recently been cited in an Office Action, e.g., used in rejecting the claims of case 107. At issue for the practitioner then, is how to determine whether these references 108-109 should be disclosed in any other cases 102-106 and how best to handle such disclosure. For example, if references 108-109 have already been disclosed in one or more of the cases 102-106, there is no need to repeat disclosure. In another example, reference 108 may be a non-U.S. patent filing claiming priority to a U.S. case, and while the reference 108 itself was not disclosed in the other cases, 102-106, the U.S. filing of the case might have been, and thus the specification (and possibly claims) would already have been submitted to the appropriate examiner. A similar situation occurs between U.S. patent publications and issued U.S. patents that originate from the same patent application.

As will be discussed in greater detail below, a method, system, and apparatus according to example embodiments may be configured to automatically assist in reporting newly discovered references between cases such as those shown linked in FIG. 1. Generally, a database or similar construct may be used to store information related to the cases 102-106 such as docket number, serial number, filing date, priority data, and other patent metadata known in the art. Database entries can also be used to indicate the relations between cases as shown in the example of FIG. 1. At a particular time, a program may examine the cases currently disclosed in a case, determine all of the references disclosed in related/linked cases, and determine any differences therebetween. These differences may be used as a basis for creating additional IDS submissions, e.g., by determining references that have been reported/cited in a related case but not in the case being analyzed.

While this automatic analysis of cited art is useful, this type of linkage and reporting between cases may lead to a geometric increase in the amount of disclosures. For example, it may be assumed that references 108-109 were not previously disclosed in cases 102-106, and that references 108-109 needed to be reported in all of the cases, then this could lead to five IDS filings, one for each of cases 102-106. Each IDS would list two references, patents 108 and 109. These may not propagate simultaneously to all cases, because not all of the cases are directly linked. For example, it might first be determined that the references 108-109 needed to be reported in case 106. After an IDS submission is recorded in case 106, it would only then be determined that references 108-109 need to be reported in cases 104 and 105. This may propagate in a similar manner to cases 103 and 102.

Thus, FIG. 1 shows that in the case where the practitioner wants maximum reporting in order to minimum exposure to a any charge of inequitable conduct, the number of references disclosed in all of n-cases where each of the n-cases are linked in this way would be equal to a1+a2+ . . . +an where each of a1-an are the number of unique references originally reported or cited in each case. In this analysis, if the same reference is originally reported or cited in multiple cases, it can arbitrarily be assigned to one of the cases.

So, if it was assumed that an average of six unique references (which includes the cases 102-107 themselves being considered references in others of the cases) was cited during the lifetime of each of the six cases 102-107, this would result in 6*6=36 references being cited in each case, with 6*5=30 being reported in a supplemental IDS. The latter number is determined by assuming that the first six references disclosed in each case were either cited by an examiner or originally submitted with an IDS for reasons other than case linkage, and therefore would require no supplemental reporting due to cases being linked. This would result in 30*6=180 additional references being cited overall due to the cases being linked, and is generally indicative of an increase in supplemental IDS filings. Each of the 180 references would at least take up a line on a Form 1449 (the form currently used by applicants to disclose references), although the actual number of individual IDS submissions would depend greatly on timing and source of references, and therefore estimation of IDS filings and associated costs is not further considered here.

It will be appreciated that the numbers of references cited in a particular case can rise with both the number of linked cases and the number of references cited in each case. For example, if a seventh case was linked with these six cases 102-107 and ten unique references were disclosed in that seventh case, then each of the six cases 102-107 would require a disclosure of 10 more references, and the new case would require the disclosure of 36 references, resulting in 36+10*6=96 additional Form 1449 line items being submitted, in addition to the 180 line items that may already have been submitted.

Regardless of the additional burden caused by these filings, Applicants will still want to disclose as many references as needed in a current case. This is not only to avoid charges of inequitable conduct, but to ensure that the best art is being considered by the examiner, thereby ensuring the most complete examination possible and strengthening the presumption of validity of any issued patent. Nonetheless, there are cases where practitioners (and examiners) would want to reduce the volume of these submissions. For example, if an applicant received an Office Action with references 108, 109 cited in case 107 one day, and three days later received a notice of allowance in case 105, the practitioner would have to make the difficult decision of whether to pull case 105 out of allowance to have the references 108, 109 considered.

One way of avoiding this is for the practitioner to carefully review the references 108, 109 to determine relevancy. However, this raises other difficult issues. First, if the number of newly discovered references is large, practitioners simply may not have the time to review each case in sufficient detail to see if it is relevant. Further, practitioners would like to avoid the legal liability that could be incurred by such an analysis. Interpretations of teachings in the art are often subjective, and a practitioner with a limited budget cannot hope to compete with a litigation team with a far higher budget and the goal of showing that a practitioner was out to deceive the patent office.

Nonetheless, there are still benefits in reducing the size of IDS submissions. For example, a recently issued U.S. Pat. No. (7,651,688) shows that over 900 references were submitted by the applicant in a number of IDS submissions. The examiner cited nine references based on a search of the prior art. The resulting file history includes 13,689 pages of non-patent or foreign prior art, and that page count does not include the pages of the US patent documents that would be inherently included in the submissions. Further, most of those documents were submitted after the applicant had already received a notice of allowance. While possibly an extreme case, based on current jurisprudence this type of disclosure is seemingly the only way to avoid the heightened standards now being used in asserting inequitable conduct. Still, it is unlikely that an examiner could reasonably consider such a massive submission in the time allotted for such a task. Further, a litigator might argue that such a submission was nonetheless intending to deceive by hiding a relevant “smoking gun” reference in a massive library of irrelevant data.

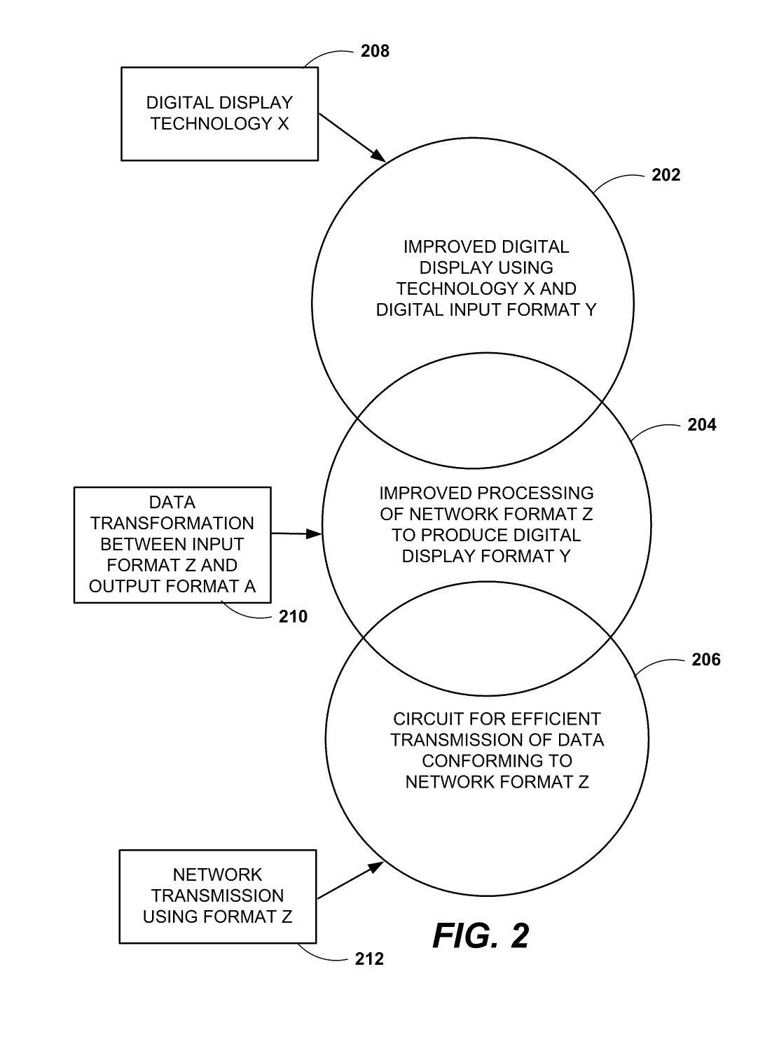

It is desirable to give practitioners (and patent examiners) a way of filtering this reference data in a way that exhibits both good faith and sound reasoning. One way in which this can be done is shown by example in the block diagram of FIG. 2. Generally, FIG. 2 represents three theoretical patent applications 202, 204, 206 whose claimed subject matter is represented in the style of a Venn diagram. Subject matter of 202 relates to an improved digital display using technology X and digital input format Y. Subject matter of 204 relates to improved processing of network format Z to produce digital display format Y. Subject matter of 206 relates to a circuit for efficient transmission of data conforming to network format Z. Blocks 208, 210, and 212 represent references that might be cited in prosecution of respective cases 202, 204, and 206.

In the terminology used herein, these cases 202, 204, and 206 would be subject matter linked, and not, for example, continuations one from the other. While this example is somewhat simplified, it illustrates conditions under which a practitioner may want to link case 202 to 204, and link case 204 to 206, but not to link case 202 to 206. Even so, with just this linkage, submission of reference 208 in case 202 relating to display technologies cause reference 208 to also be reported in case 204 (the desired result). However, this reporting of reference 208 in case 204 would then indicate the reference 208 needs to be cited in case 206, because of the linkage between cases 204 and 206. However, case 206 is related to network data transmissions, not digital displays, thus reporting of digital display reference 208 may not be the desired result. Similarly, reference 210 may be relevant to cases 204 and 206 due to teachings regarding format Z (and because it was cited in case 204), but is possibly not relevant to case 202. Note that this “migration” of references between unlinked may be an unintended effect of automatic reporting based on linkages.

Embodiments described herein are intended to better prevent possible irrelevant material from “migrating” between cases 202 and 206. Various implementations will be described below, but generally it involves assigning a “hop” value to particular IDS submissions in the linking case 204. Generally, the assignment of a hops value may be automatic, e.g., created when a particular document (e.g., IDS submission) is created and filed. Thus, if reference 212 is cited in case 206, it will be duly submitted in an IDS submission in case 204. However, the database tracking the submission will assign a “hop” value to reference 212, meaning that the reference 212 migrated from a subject matter linked case 206, and was not cited in a more directly relevant way, such as cited in a continuation of 204, cited by the examiner in 204, cited in a foreign filing claiming priority to 204, etc. Thus, when a determination is made in case 202 of whether art needs to be cited from case 204, the determination may drop any references being cited in case 204 whose hops value exceeds a predetermined value.

It will be appreciated that if there was some commonality between cases 202 and 206, the practitioner could create another linkage between those cases, in which case the reference 212 would be added to case 202, but still including the added hops value. The hops value may be a binary value, e.g., reference is considered if hops is zero, and not considered if non-zero. In other embodiments, this value could be incremented by each case to which it migrates, and some threshold (e.g., hops=2) may be used to determine whether the reference is indicated as needing to be reported. It will be appreciated that this use of zero and non-zero numerical values is merely representative; other representation schemes may achieve the same result in the same way without utilizing numbers at all, e.g., using alphabetic characters.

It will also be appreciated that, in the example of FIG. 2, the automatic assignment of hop values need not prevent reference 210 from being reported in case 202 even though it may not be relevant, because case 202 is still directly linked to case 204 in a subject matter relationship. Also, assuming a line of cases has a direct familial or inheritance relationship (e.g., each application in a string of continuations) then the hops may always be set to the zero value and never incremented even when a reference passes from case to case in this relationship. This behavior may be desired in some cases (e.g., between divisionals that claim similar respective methods, systems, and apparatuses) and possibly not in others (e.g., continuation with independent and distinct claim scope than that of parent).

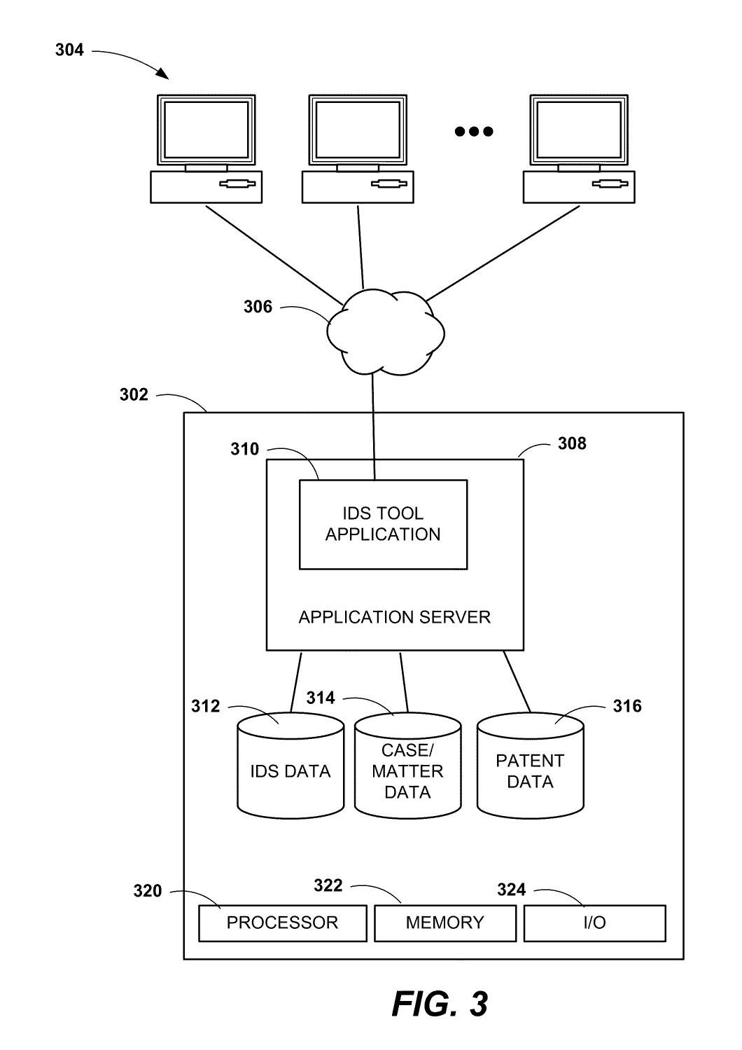

Now, a more detailed implementation of an automated patent tracking system is discussed in reference to FIG. 3. In one embodiment, a server 302 can be utilized to centrally perform computer operations described herein. The server may include conventional computer hardware and software as known in the art, including a processor 320, memory 322, and input/output circuitry 324. The server 302 may be used at least to receive, store, and process data, with or without direct human interaction with a user interface of the server 302. For example, one or more client computers 304 may facilitate human interaction with the server 302 via a network 306.

The server 302 may include an application server 308 that manages interactions between one or more core software components (e.g., application 310) and client software (not shown) on the client computers 304. In one embodiment, the client software may include a web browser, and the application server may include a web-based server such as Tomcat by the Apache Foundation or Sun Glassfish by Sun Microsystems. Both Tomcat and Glassfish are Java servlet containers that allow dynamic web content to be developed using the Java programming language and Java application program interface (API). The system may utilize other web application frameworks using technologies such as PHP, ASP.NET, Ruby, etc, and may be embodied in alternate computerized forms, e.g., a monolithic program.

The application 310 may manage storage and access of persistent data by way of a database. Relational databases such as MySQL, SQL Server, Oracle, etc., allow efficient storage of data in a structured form. Example databases in FIG. 3 include an IDS-specific database 312, case/matter database 314, and a patent database 316. These databases 312, 314, 316 may include any manner of data storage paradigm. In the present example, they may include common or independent relational databases that may run locally on the server 320 or be accessed from another apparatus via the network 306.

The IDS database 312 may contain the majority of data discussed herein related to patent references, submission forms, and relationships between matters/cases. The matter/case database 314 may include general data related to a particular filing, such as attorney/client identifiers, filing date, inventorship, etc. The client/matter database 314 may be maintained by other systems and users, such as where the database 314 is utilized by case management and billing system. This facilitates integrating the IDS database with existing information systems However, the database 314 may also be part of the IDS database 312, e.g., in cases where no separate case management system is used or needed. Finally, the patent database 316 may contain data related to pending and issued U.S. patents, such as patent text, art unit, classification, sub-classification, serial number, etc. The same (or similar) database 316 may also be used to other patent related data, such as international and foreign patent applications and publications, non-patent publications, affidavits, etc.

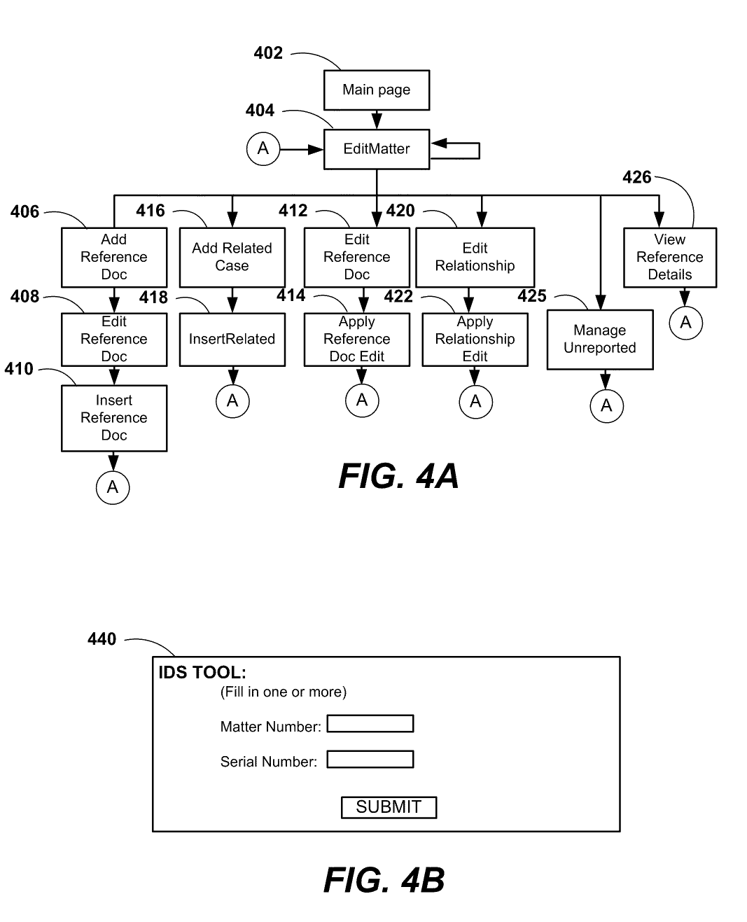

Generally, the application 310 may interact with clients 304 via dynamically generated web documents. In an application server such as Tomcat, particular Java object known as servlets handle document requests through Hypertext Transport Protocol (HTTP) methods such as GET and POST. In reference now to FIG. 4A, a block diagram shows a sequence of servlets that may be used in an application according to one embodiment. Block 402 indicates a servlet/page that may be used as entry point into the system, as shown in screen 440 in FIG. 4B. In this example, the screen 440 allows entry of text describing a case/matter to be searched on using an identifier such as matter/docket ID or serial number. This screen 440 may be created as a static web page instead of a servlet, and may be preceded by or included with other features, such as user authentication, higher level menus/selections, etc.

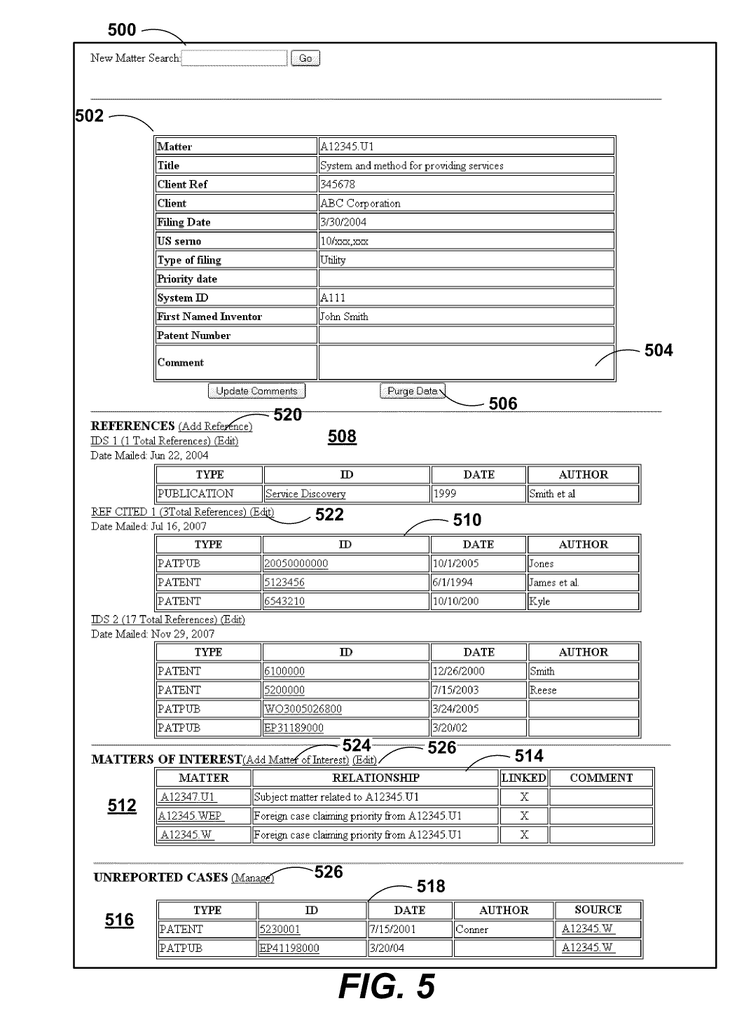

The ID of a matter is entered via 402 and sent to servlet 404, e.g., via an argument added to a Uniform Resource Identifier (URI), headers, POST data, etc. The servlet 404 displays data relevant to the selected matter as shown by way of example in screen 500 of FIG. 5. In screen 500, table 502 indicates data that may be extracted from database 314 in FIG. 3, such data including identifiers, title, client, filing date, serial number, type of filing, inventor, etc. The table 502 also includes a comments text field 504 that may be used for adding any text of interest in the case, e.g., “to do's,” status, problems/issues. Also, a control 506 allows for purging the data related to the case, e.g., for complying with corporate information technology data retention policies.

Screen 500 further includes a section 508 generally denoted as “References,” which includes a list of documents each including a list of patent references. In the U.S. patent system, this includes two types of documents: references cited in an Office Action (PTO Form 892), and IDS forms submitted to the Office by the Applicant (PTO Form 1449). For each document, a table (e.g., table 510) is presented that lists all references included in the document. Each row of the tables lists, for example, the type of document, an identifier (e.g., patent/publication number, publication title), critical date, and author/inventor. In the illustrated embodiments, table entries in the ID columns include hyperlinks that may enable accessing the document of interest from US or other country patent sites, local storage, search engines, etc. It will be appreciated that other columns may be similarly hyperlinked. For example, entries in the “Author” column could link to information related to the listed author/inventor, such as other patents/publications linked to the author, location of author, etc.

Next, section 512 of screen 502 is titled “Matters of Interest,” and includes a table 514 with a listing of other cases that have some relation to the case of screen 502. The “Matter” column of includes hyperlinked identifiers that, when selected, navigate to a web page analogous to screen 502 that is associated with the matter identified in the link. The “Relationship” column describes how the matter/case in table 514 is related to the matter described in screen 502. As might be indicated by the use of the term, “of interest,” not every case listed in table 514 need result in art cited in a listed case being cited in another case.

For example, a case listed in table 514 may have a broad disclosure but relatively narrow claims, such that it may not be necessary to automatically include art cited in that case in the present case. Thus, the column labeled as “Linked” allows a case to be listed in table 514 without automatic linkage of all art cited in that case with the present case. This may still be useful to allow a practitioner to perform a case-by-case determination, or at least provide “placeholder” for follow-up. The “Comment” column provides a place to annotate this and other reasons why a particular case is shown in table 514.

As mentioned above, linkage of case in table 514 to the present case of screen 502 may cause an automated determination that art/references cited in one case have not been cited in the present case. This is shown in section 516, which includes table 518. As with the tables in section 508, table 518 includes columns such as the type of art/reference, identifiers, dates, and authors. Table 518 also includes a “Source” column, which indicates from which of the matters of interest of section 512 the unreported reference originated. The table 518 may be generated “on-the-fly” whenever page 502 is generated. This may reduce data storage needs, as well as making some aspects of implementation simpler. For example, if one case is erroneously linked to another, unlinking the cases would also require removing/modifying separate data structures that describe the data in table 518. By generating table 518 dynamically, such changes would be automatically reflected when page 502 is reloaded or refreshed.

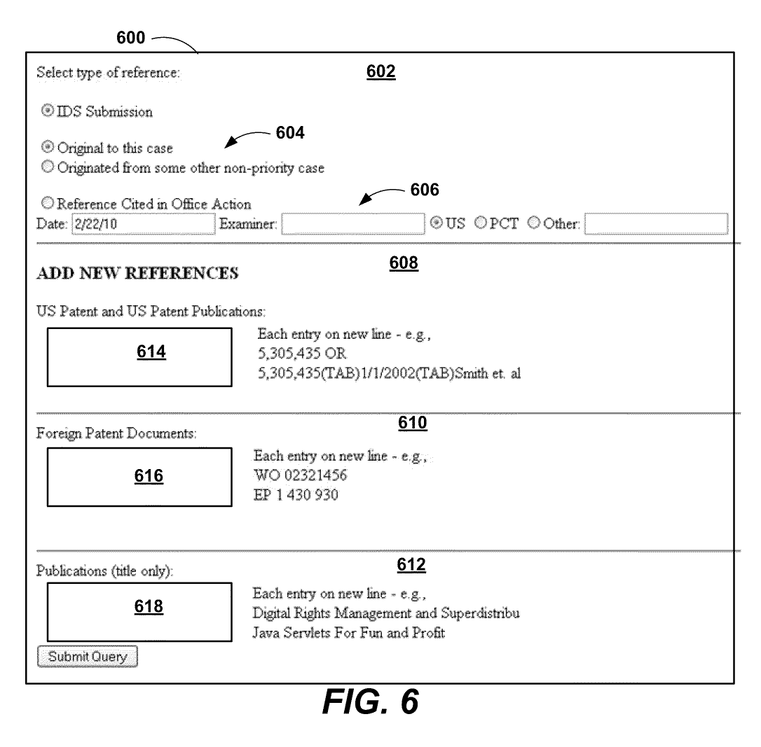

Again referring to References section 508, a link 520 or other control allows adding a new reference document (e.g., IDS or References Cited in an Office Action) to the present case. In the context of the servlet diagram of FIG. 4A, selecting link 520 may invoke servlet (or static web page) 406. The presentation by servlet/page 406 is shown in form 600 of FIG. 6 according to an example embodiment. Form 600 includes section 602 that is used to classify the type of document, e.g., IDS submission or Reference Cited in an Office Action. In the former case, an option control 604 (e.g., radio buttons) allows specifying whether the IDS is “original” to the present case, or originated from another case, e.g., one linked as subject matter related.

As used herein, the term “original to the case” signifies that art cited in the IDS was identified by the applicant, or was cited in a case with a priority relationship with the present case. In such a case, the hops count for all references should be set to zero, or any other value that signifies that cited references should propagate to directly related cases. However, if the art listed in the IDS came from a subject matter related case, selecting the lower option from control 604 will set all the hops to some predetermined value, e.g., one. This control 604 is provided as a convenience to the user. The user may be able to set hops values on a reference-by-reference basis, as will be described later hereinbelow.

Also seen in section 602 are interface elements 606 that allow setting other data related to an Office Action document or the like, such as date, name of examiner, and specifying whether the Office Action is from the U.S. Office or elsewhere. Although the present embodiments are described as applicable to U.S. IDS filings, the tools may need to deal with non-U.S. cases, e.g., to track references cited in foreign cases that claim priority to a U.S. case, vice versa. One other note regarding elements 606, the date field may be common to both an IDS submission and References Cited in an Office Action, and therefore may be relocated elsewhere in section 602 or otherwise highlighted as being common to both types of documents.

In sections 608, 610, and 612, respective text editing fields 614, 616, and 618 provide for entry of lists of document identifiers. It should be noted that the arrangement of sections 608, 610, and 612 mirrors both the Form 1449 used in IDS submissions and PTO Form 892 used for listing references cited in Office Actions. As a result, users may electronically transfer over the reference data, e.g., by cutting and pasting from the source documents. In particular, field 614 may include lines with either the reference number or tab delimited data from forms 1449 and 892, which also includes a date and inventor for each document. While such additional data may also be placed in fields 616 and 618, listings of foreign patent documents and non-patent publications may use non-standard formats. Accordingly, it may be more efficient to enter that additional data at a later stage than deal with complicated parsing that may be needed to deal with those formats.

It will be appreciated that some data entered in fields 614, 616, and 618 may describe references already in the database, while others may be new to the database. It should be apparent that any given prior art reference should be unique in the database, so that duplicate submissions are avoided. Thus, each entry from fields 614, 616, and 618 is parsed to determine the unique identifier used by the database, and a lookup is performed. If the lookup is successful, the data related to the reference is retrieved. Otherwise the reference is considered as yet to be entered into the database.

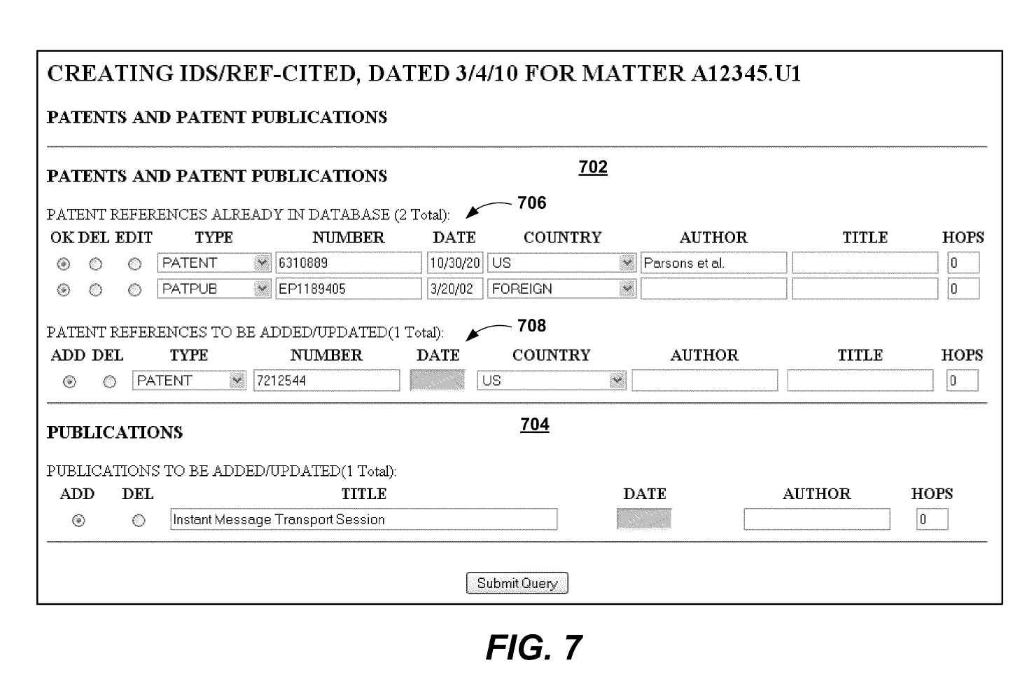

Submission of the form 600 of FIG. 6 may invoke servlet 408 as shown in FIG. 4A. The data in fields 614, 616, and 618 are passed to servlet 408, which performs the parsing and lookups described above. Then a second form, shown as form 700 in FIG. 7, shows the status of such parsing/lookup and provides for additional editing. In particular, form 700 is divided into two sections, section 702 related to both U.S. and non-U.S. patent references, and section 704 related to non-patent publications.

Both of these sections 702, 704 may be further divided into two sub-sections, which is illustrated here as subsections 706, 708. Subsection 706 includes controls for editing references already in the database, and subsection 708 includes controls for editing entries that will (but have not yet been) entered into the database. It will be appreciated that some entries in subsection 706 may show that there is erroneous data in the database, and the entry fields (along with the ADD, DEL, and EDIT radio buttons on the left) allow modifying the data at this state, through selection of the EDIT radio button. Also, the user may find at this stage that an entry may be duplicative or reflect some other error, and therefore may wish to delete the entry from the current document submission by way of the DEL (delete) button. It may be assumed that when DEL is selected for an existing entry in subsection 706, that the reference will be removed from the present document, but will not be deleted from the database, as the reference may be valid for other cases.

Note that the hops values in the rightmost columns may be pre-filled based on selections noted above in form 600, and may be automatically incremented in some embodiments. The user may also modify individual hops values in form 700. It should be noted that, unlike the other patent and publication data entered in form 700 (e.g., type, number, date, etc.), the hops values need not be unique to a particular reference, but instead are tied to both the particular reference and a particular case/submission document. For example, a patent reference may have a hops value of one relative to one case, but a value of zero relative to another. The particular database structures that allow this are discussed further hereinbelow.

It can be seen that section 704 has only one subsection because the theoretical publication in this case is not in the database. It may be noted at this point that publications may present a special challenge when trying to determine uniqueness in the database. Unlike patent-type references, there may no standard unique number or other indicator that can be used to unequivocally determine whether two references are the same or different. For example, in one reference submission document a publication may be listed as “Trees: A definitive reference guide, 3rd edition” by Jones, 1992. Another reference document may list a publication as “Trees, a definitive reference guide,” by Jones et al, 1992. In this case, the difference in the author listing may be an indicator that the references are different, but it is also possible that upon further investigation it is found that these listings refer to the same document. In other cases, the titles may be different only by capitalization or punctuation, and thus may be determined by inspection to be referring to the same.

There may be a number of possible ways of determining identity between non-patent publications. Some reference numbers such as International Standard Book Number (ISBN) may be applicable for certain types of references (e.g., published books sold commercially), but again may not be universally applicable to other publications (e.g., magazine articles, professional journals, etc.). Each publication may be analyzed separately and given a unique identifier by the user. In the present case, a special form of the title is used to form an identifier that may be sufficiently unique for present purposes. In one embodiment, a string is formed using capitalizing all characters of the title, and then all non-alphanumeric characters are removed. The first n-characters of this string (e.g., 32 characters) are then used as an identifier (e.g., by truncating the full string to a predetermined value), e.g., used to index data entries.

In the example given above, the two publications would have as identifiers (assuming the identifiers are truncated to 32 characters or less) of “TREESADEFINITIVEREFERENCEGUIDE3R” and “TREESADEFINITIVEREFERENCEGUIDE.” Thus a system may still flag these publications as being different, even if it might be apparent to a person that they could be the same. Nonetheless, a system that is reliant on human data input may inevitably be susceptible to human input errors (e.g., misspellings), and so additional mechanisms described herein facilitate detecting and dealing with such errors.

In reference again to form 700, upon submission of form 700, another servlet (shown as servlet 410 in FIG. 4) determines any changes made to form 700, and attempts to insert the newly created document as well as any newly added references into the database. The servlet 410 may provide a confirmation, indicate errors, etc. as a web page output. In other embodiments, the servlet 410 may return to the invoking servlet to correct errors if errors are found, and return to servlet 404 if submission is successful. In such a case, the newly added document may be listed in section 508 of screen 500.

Other tasks that may be performed by servlet 410 include addressing the need for reporting Office Actions in IDS submissions, and the effects of the document submission on related cases. As case law has indicated, patentees may now be expected to not only cross-cite patent references between related cases, but to include Office Actions that have arguments used by other examiners in rejecting claims in the related cases. Thus, if the currently inserted document is flagged as a Reference Cited in an Office Action (e.g., via control in section 602 of FIG. 6), then the system can also automatically create an entry that describes the Office Action. This entry may be added as a non-patent publication, and given a title such as “Office Action dated dd/mm/yyyy in S/N xx/xxx,xxx.”

It will be appreciated that this an Office Action added as a publication should not be reported in the originating case, but only in related cases. Accordingly, these publications may be given a special database identifier, e.g., “%% OA-SN-XXXXXXXX-DDMMYYY.” In such a case, the matter to which the Office Action pertains can look for this identifier and suppress indicating that the Action needs to be reported. In other cases, a special class of reference may be created, e.g., OFFICE_COMMUNICATIONS. Such references could be uniquely indexed by date and serial number of case to which the communication pertains. In such a case, a check would be made to see if the document has the same serial number as that of the matter of interest, and if so reporting would be suppressed.

As servlet 410 is adding new documents and reference entries, this may be immediately of interest in related cases. Thus, servlet 410 may show an alert page (not shown) that lists the related cases and any references from the present case that may need to be reported in those cases. It will be appreciated that the listing will also automatically show up in the other cases when they are viewed from the database. However, such viewing may not occur until some later, inopportune time, e.g., upon receiving a notice of allowance in the other case. Thus the alert page may at least be noted (e.g., printed out) and used to trigger additional actions (manually or automatically reporting of the new references).

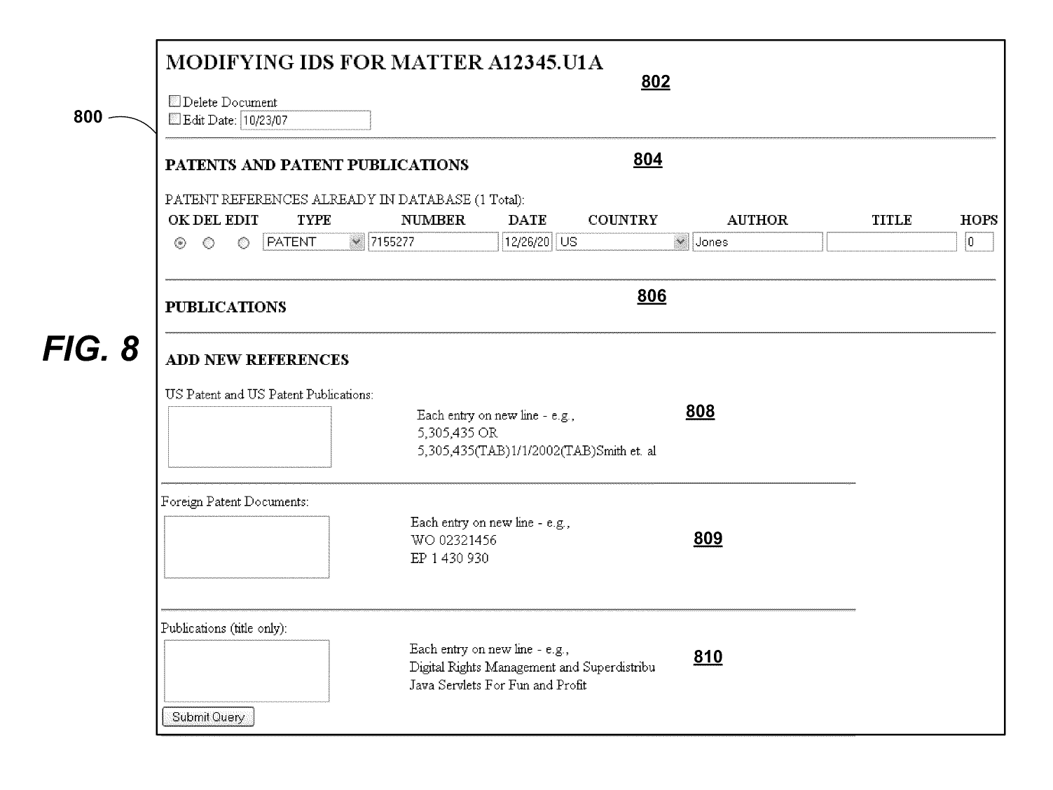

In reference again to FIG. 5, it will be appreciated that a user may later wish to modify erroneous reference data entered in section 508. Accordingly a link 522 (or other control) allows editing of a particular document and/or references within the document. Link 522 may invoke servlet 412, which retrieves the document and reference data from the database, and presents a form such as form 800 shown in FIG. 8.

Form 800 includes a section 802 for editing document specific data, such as date and deleting of the document altogether. While not shown here, the section 802 may also include a section for changing the type of document, e.g., from IDS to References Cited, and vice versa. In sections 804 and 806, the references in the document may be edited in a similar manner as described in the form 700 in FIG. 700, including deleting particular references. Analogous to form 600 in FIG. 6, form 800 includes sections 808-810 for adding additional references to the document. Upon submitting the form 800, an object such as servlet 414 in FIG. 4 may process the data in form 800, such as by modifying changed data and inserting new references from sections 808-810. Such insertion may be done directly, or via an intermediate checking form such as form 700 in FIG. 7.

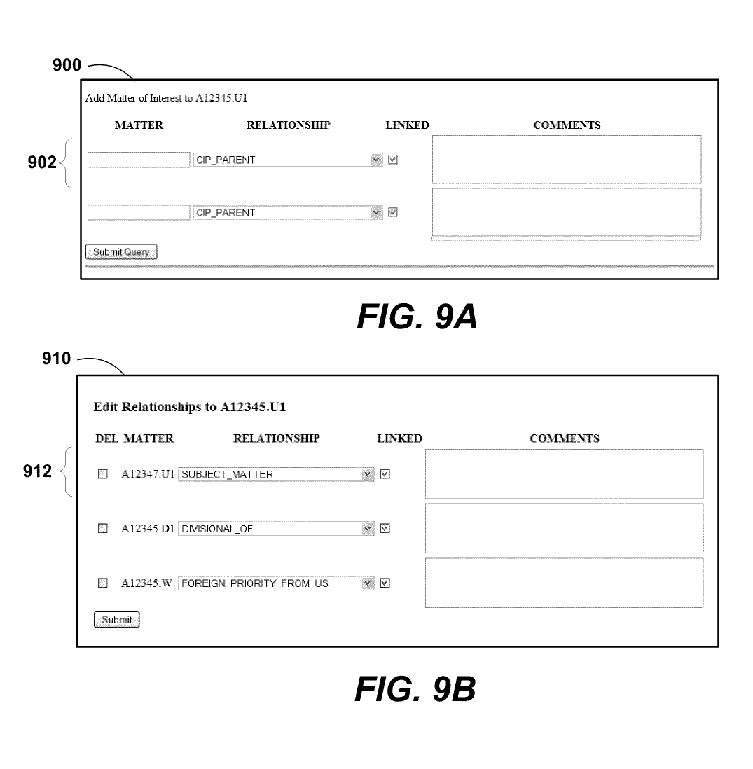

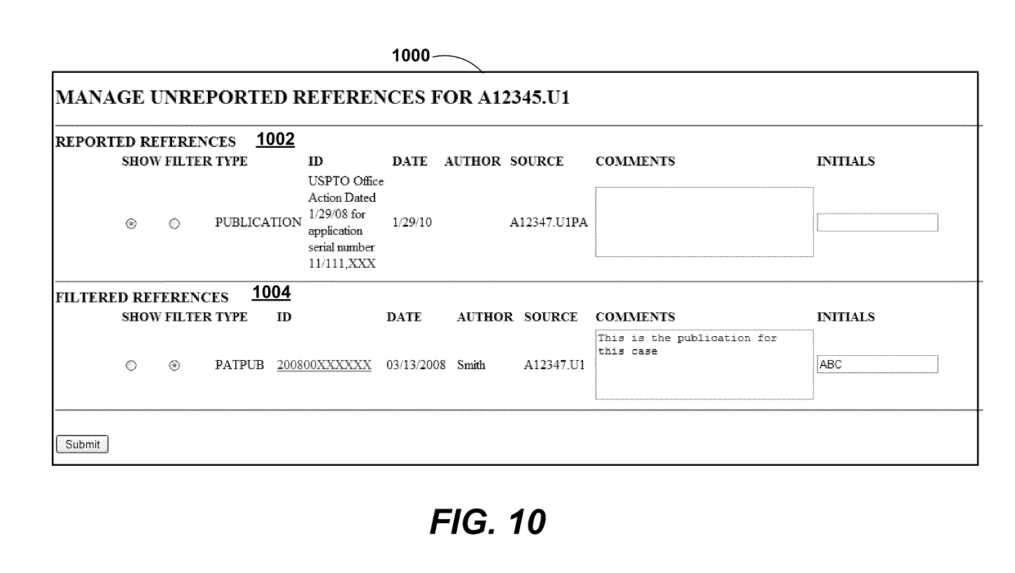

With reference again to FIG. 5, section 512 lists other cases that may have a relationship with the case detailed in screen 500. Controls 524 and 526 allow for editing this data, which may respectively invoke servlets 416 and 420 shown in FIG. 4. Servlets 416 and 420 may present respective forms 900 and 910 shown in FIGS. 9A-B. In form 900, a number of rows such as row 902 allow entering a matter identifier, relationship, comments, and a LINKED selector that indicates whether automatic determination of unreported references (e.g., shown in section 516 in FIG. 5) should be performed. The data in form 900 may be submitted to servlet 418 in FIG. 4 Form 910 uses similar web components as form 900, with the addition of a DEL selector, as can be seen in row 912. Submission of form 910 results in an update to the database via servlet 422 in FIG. 4. Both servlets 418 and 422 may perform validity checks, report errors, and insert/update the data into the database.

As was previously discussed, the unreported references section 516 may be dynamically created each time the servlet 404 that creates screen 500 is invoked. At some point, a practitioner may wish to prevent a reference from appearing in section 512. For example, as was previously discussed, a discrepancy in naming documents may result in an already-reported reference showing up in section 512. In other cases, a practitioner may have analyzed a reference and decided that the reference is not materially relevant. To handle these situations, selection of link 526 in section 512 may invoke servlet 425, which facilitates managing these references. Servlet 425 may generate form 1000 that is shown in FIG. 10.

The form 1000 includes a section 1002 that includes references that are already being displayed in section 512 of screen 500. A second section 1004 shows references that have already been filtered. There may be a row for each reference, and in this example the sections 1002, 1004 include one row each. Each row provides a control (e.g., radio button) for showing or filtering the reference, a text field for entering comments, and another for entering initials. As will described further hereinbelow, each of the rows in at least section 1004 will have a database entry that both filters the reference from being displayed in section 512 and provides additional information seen in form 1000. The entries in section 1002 may be dynamically generated in a similar manner to the entries of section 512, and need not have any persistent data stored for the entries, unless a comment and/or initial has been entered in the respective text fields.

In reference again to FIG. 4, one servlet that has not yet been discussed is servlet 426 denoted as ViewReferenceDetails. Generally, this servlet 426 may be invoked when a link or other control is selected from a form/page such as shown in screen 500. In one example, the servlet 404 that produces the screen 500 may automatically form links for patent references that direct the browser to an external site, such as the USPTO web site for US patents and patent publications. Similar linkages may be formed for foreign and international patents. In other cases, the links may navigate to an Internet search engine using the identifier as a lookup query. In these cases, there may be no need to invoke servlet 426.

In other embodiments, a local database of the associated references may be maintained, and servlet 426 may be used to retrieve and display documents from that database. For example, when a patent reference is entered such as via form 600, the servlet 406 could retrieve the reference from an external source and store a copy of the reference locally if not already in the database and/or previously stored. Similarly, the practitioner may have an electronic copy of non-patent publications and enter those through the system, e.g., by adding upload controls to section 704 in FIG. 7.

The forms/screens FIGS. 5-9B may be seen as a front end (view) of a model-view-controller (MVC) system design. As was mentioned in the discussion of those screens, one or more databases (e.g., databases 312, 314, and 316 in FIG. 3) may work at the “back-end” to maintain the model of persistent data. In one embodiment, a relational database such as MySQL or SQL Server can be used from a network server that is part of or separate from the application server that generates the views. In reference now to Listing 1 below, an example sequence of SQL commands are shown that can be used to generate relational database tables according to an example embodiment.

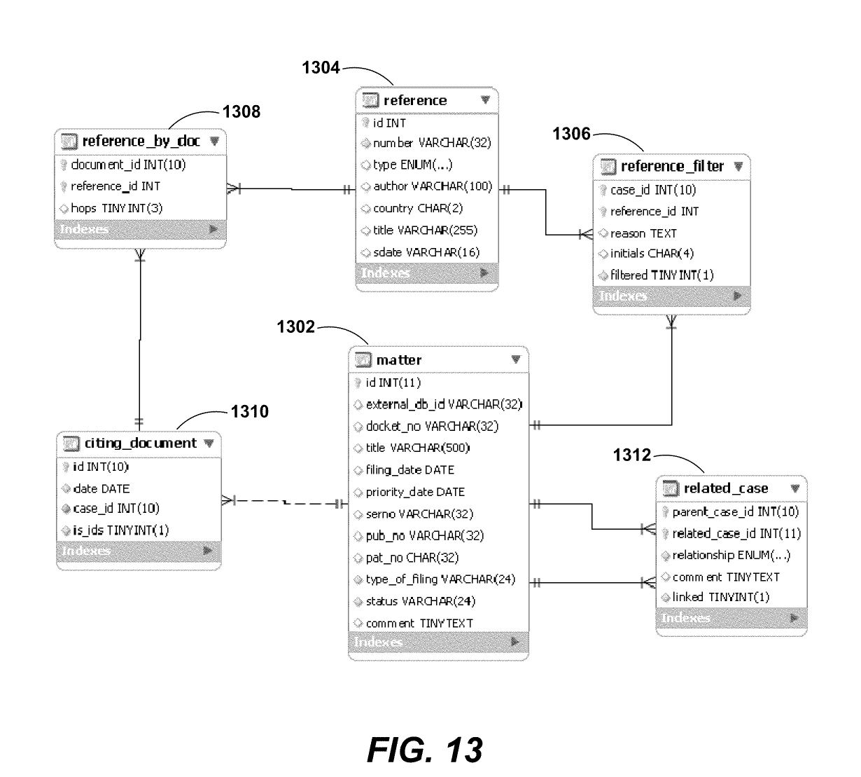

In reference now to FIG. 13, an entity relation diagram illustrates data tables used in a relational database according to an example embodiment. A matter table 1302 includes data that may be of interest to the practitioner managing the case. Such data may include docket number, filing date, priority date, serial number, publication number, etc. The table 1302 is include an external database identifier in situations where the IDS tracking system interfaces with another system (e.g., docketing, case management, billing) that tracks this data independently of the IDS tracking system. In such a case, the other fields in the table may be set to null or blank values, and servlet code may be modified to perform additional lookups to the external database in order to obtain this type of data. Even in such a case, the IDS system may populate the comments row of table 1302 to add IDS-specific comments about particular matter entries.

A “reference” table 1304 stores data for both patent and non-patent documents. The table 1304 is indexed by the “number” column, which is a variable length character data type that may be designed to accommodate various known patent numbering schemes, as well as for storing unique identifiers for publications, the formation of which using the publication title is described in greater detail above. A separate, auto-incrementing primary key, id, is used, to ensure that changing of the number (and other fields) due, e.g., to an erroneous entry, do not cause problems with the other tables that have foreign key that reference this table 1304. The table 1304 also includes a “type” column, which may include enumerated types or strings such as ‘PATENT’, ‘PATPUB’, ‘PUBLICATION’, ‘APPLICATION’, and ‘OTHER.’

The reference_filter table 1306 is intended to allow the filtering of references from being displayed in section 512 of screen 500, and reflects data entered as shown in FIG. 10. Each row of this table 1306 links one reference to one case/matter, and includes additional data such as reason and initials, e.g., to document why a case was or was not filtered and by whom. Note that the “filtered” column allows persistent storage of non-filtered references, such that reason text and initials may be preserved even when filtering is not needed.

The reference_by_doc 1308 table links a reference 1304 to a single reported document, the latter being described in a citing_document table 1310. This table 1310 may be used for IDS submissions, PTO, and/or non-PTO documents, e.g., PCT search reports and written opinions. Each row of the citing_document 1310 is associated with a single case by way of the case_id index. Thus finding whether a reference has been reported in case may involve determining each IDS/reference cited document in the case, and then enumerating each document in that document.

The related_case table 1312 links one case with another. Of interest in this table 1312 is the enumeration of relationship types, which on one example may include CIP_PARENT', ‘CIP_OF’, ‘CONTINUATION_PARENT’, ‘CONTINUATION_OF’, ‘DIVISIONAL_PARENT’, ‘DIVISIONAL_OF’, ‘FOREIGN_PRIORITY_FROM_US’, ‘FOREIGN_PRIORITY_PARENT’, ‘INCORPORATES_BY_REFERENCE’, ‘INCORPORATED_BY_REFERENCE_IN’, ‘SIBLING’, ‘SUBJECT_MATTER’, ‘US_PRIORITY_FROM_FOREIGN’, ‘US_PRIORITY_PARENT’, and ‘TBD’.

It will be appreciated that linkages may be two way, and may be of different enumerated types. For example, if case B is linked in the database as a CONTINUATION_OF case A, a second entry may also automatically be entered that indicates case A is CONTINUATION_PARENT of case B. One case where automatic second entries may not be needed includes foreign cases, which may not have an duty of disclosure analogous to that of the U.S. In such a case, there may be no need to create a related_case 1312 entry with a foreign/international case as parent or child of a U.S. case.

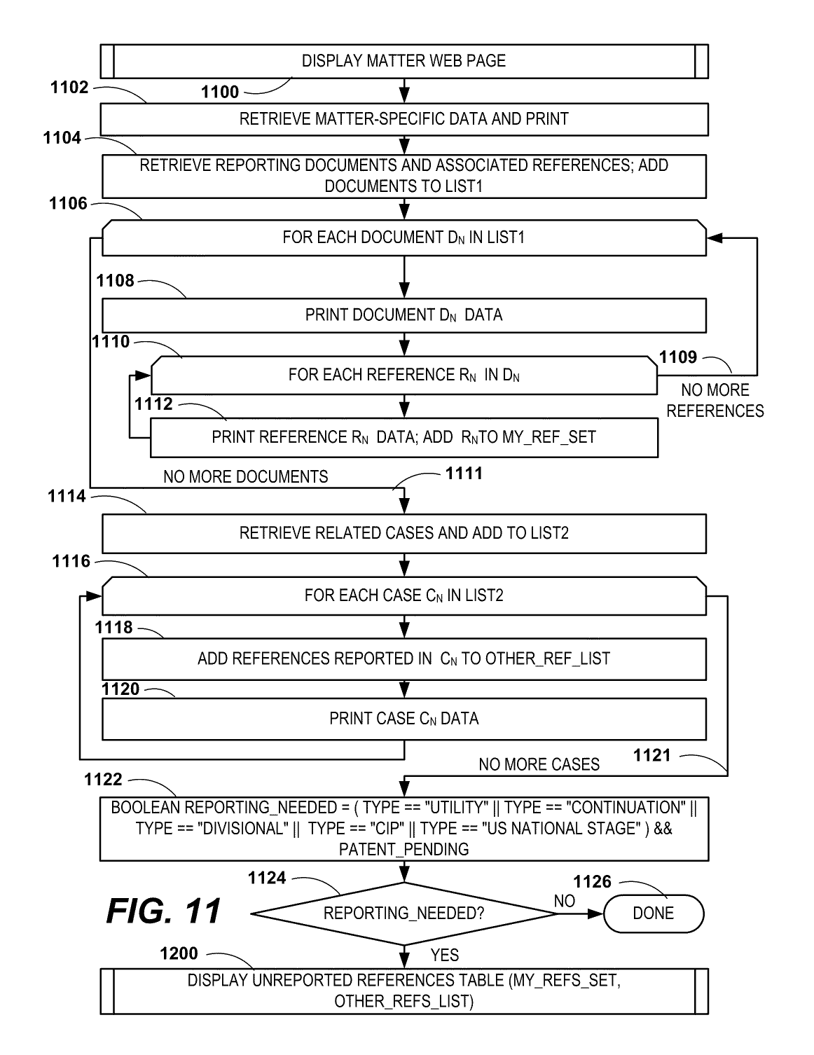

In reference now to FIG. 11, a flowchart illustrates a procedure 1100 for preparing a web page (or similar user interface view) of a patent matter according to an example embodiment. The procedure 1100 may be applicable for displaying a view such as shown in screen 500 of FIG. 5. First, matter specific data is retrieved 1102 (e.g., from a database) and displayed, e.g., such as seen in table 502. A list of reporting documents (e.g., IDS submissions, references cited) is retrieved 1104 as are references listed/reported in those documents. These documents are also added to a list (e.g., array) denote here as LIST1.

Next, a loop 1106 is entered that iterates over each of the documents in LIST1. This outer loop 1106 may, among other things, be used to display documents and references such as shown in section 508 in FIG. 5. For each document, the data for the document (e.g., date, type) is printed 1108, and then a loop 1110 is entered which iterates over all the references reported in the current document. For each of the reference, data is printed 1112, and the document data (e.g., a data structure representing the document) is added to a set denoted as MY_REF_SET. As may be appreciated by one of ordinary skill in the art, a set may be a container that enforces that inserted objects be unique (e.g., as described regarding the Java “Set” and “SortedSet” classes). Generally, in an object oriented environment, a set may require each object to have a comparator that determines whether one object of the same type is less then, greater than, or equal to another object of that type.

In the present case, the references may be compared by way of a string comparison on their identifiers (e.g., patent or patent publication numbers, titles, etc.). This may be determined also based on type, e.g., a foreign case will never return equality when compared to a U.S. case, even if the ID numbers are coincidentally identical. By modeling the references as classes using an object oriented program, a sophisticated comparator can handle these and other situations. As will be described later on, use of a set for storing the references allows for efficient determination of, e.g., whether a particular reference has or has not been reported.

After all the references for each document have been iterated through in the inner loop (completion of which is represented by path 1109) and each document has been iterated through (completion of which is represented by path 1111), the related cases are retrieved 1114 and added to another list, LIST2. Each related case in this second list is iterated through as indicated by loop 1116. All of the references reported in each case are retrieved (e.g., via reference_by_case linking table shown in Listing 1) and added 1118 to another list, denoted OTHER_REF_LIST. The data for the case is printed 1120, leading to display, e.g., of section 512 in FIG. 5. After the last related case has been processed, the loop 1116 exits as shown by path 1121.

In block 1122, a Boolean value is calculated for determining whether additional computation and display related to unreported cases is needed. In this example, the matter (or more precisely a data object representing the matter) may have a “type” value or parameter that indicates what kind of filing the matter is. In this example, the types listed all describe various U.S. non-provisional utility applications (e.g., “UTILITY,” “CONTINUATION,” etc.). This list may be expanded depending on the needs of the practice, e.g., to include design patents, plant patents, foreign patents, etc. Also tested in block 1122 is whether the patent is still pending, which may be checked, e.g., via a status variable or the existence of a patent number. For some entities (e.g., law firms prosecuting a case) the duty to submit information disclosures may no longer be needed once the entity no longer deals with the case, such as after the case issues.

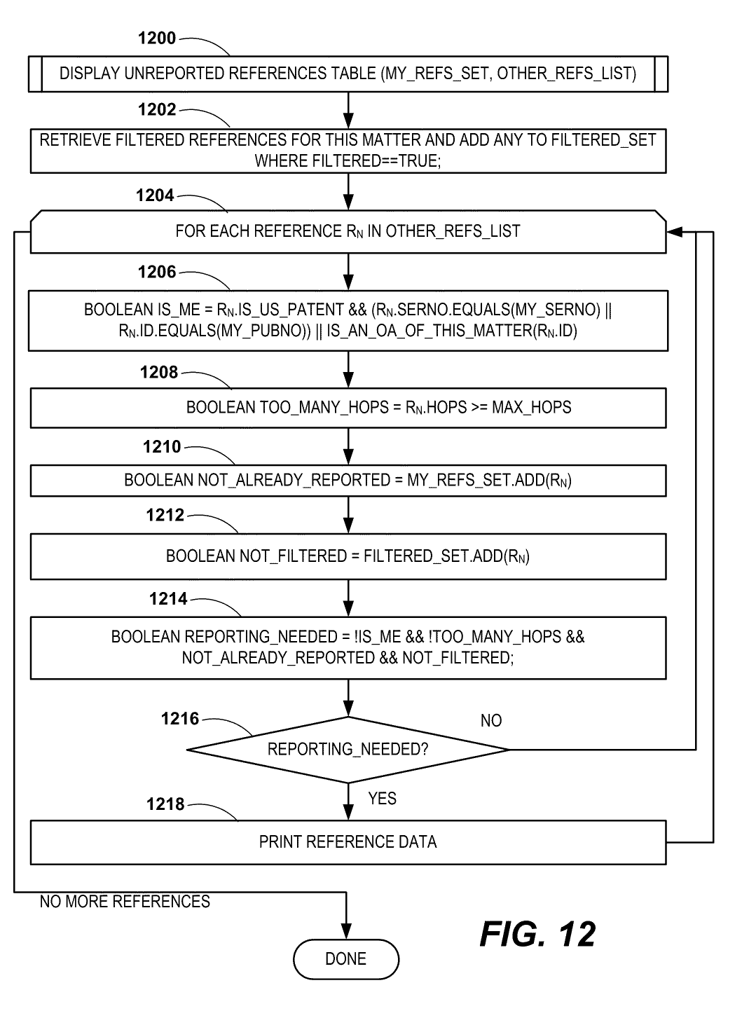

If the value determined in block 1122 determines no reporting is needed, the procedure 1100 may terminate 1126. If reporting is needed, then another procedure 1200 may be entered, the details of which are shown in FIG. 12. As may be apparent, the procedure 1200 takes into account two variables calculated in procedure 1100, the set of references already reporting in the case (MY_REFS_SET) and the list of references reported in the related cases (OTHER_REFS_LIST).

First, the procedure may access 1202 a list of filtered references (e.g., by way of reference_filter table in Listing 1, and selecting only those that have the “filtered” value set to “true”) and store them in a set, e.g., a Java Set or SortedSet. As was described above, a set is an efficient collection type for determining whether a particular object is already in the set. If insertion of the object fails, then the object is already in the set, otherwise the object is not already in the set. This is also used in steps 1210 and 1212, which will be described in greater detail below.

A loop 1204 iterates through each of the other references, where various tests are made to determine whether a particular reference needs to be indicated as requiring reporting. Block 1206 tests whether the reference relates to the currently prosecuted case. For example, another related matter may include a reference to one or both of the current matter's serial number and publication number, in which case that reporting may work its way back to the present case. Another example dealt with in block 120 is Office Actions that are stored as a special class of publication, and should not be reported in the matters to which the Office Action pertains.

In block 1208, the hops value associated with reference is tested to see if the reference “migrated” from a linkage that is too far to warrant reporting here. In block 1210, an “add” is attempted of the reference to MY_REFS_SET. If the add is successful, then the reference is not yet reported. In block 1212, an add is attempted of the reference to the FILTERED_SET. If the add is successful, then the reference is not filtered. Finally, block 1214 combines all of these Boolean values to a composite value for determining 1216 whether the reference needs reporting, in which case it is indicated 1218, e.g., by being printed out in such as is shown in section 516 in FIG. 5.

As noted above, the procedures in FIGS. 11 and 12 may be performed each time a patent matter web page is loaded. However, a practitioner may wish to know if any references need to be reported for a family of matters. In such a case, the apparatuses, systems, software, and methods described herein could include additional functionality that takes a matter/docket number query (e.g., regular expression with wild card characters) as input and returns a list of applicable matters. For each matter in the list, steps of FIGS. 11 and 12 may be performed (although printing operations in FIG. 11 could be skipped) to determine whether reporting is needed 1124, and if so displaying information about what needs to be reported via procedure 1200 (e.g., number of unreported references, listing of all unreported references).

The foregoing description of the example embodiments has been presented for the purposes of illustration and description. It is not intended to be exhaustive or to limit the claims to the precise form disclosed. Many modifications and variations are possible in light of the above teaching. It is intended that the scope be limited not with this detailed description, but rather determined by the claims appended hereto.

I/We claim:

1. A method comprising:
establishing a first linkage in a database between first and second patent applications so that first references reported in the first patent application are indicated as needing to be reported in the second patent application when data related to the second patent application is accessed via the database;
establishing a second linkage in the database between the second patent application and a third patent application so that second references reported in the second patent application are indicated as needing to be reported in the third patent application, wherein there is no linkage in the database between the first patent application and the third patent application analogous to the first and second linkages;
detecting via the database that the first references have been reported in the second patent application; and
preventing an indication that the first references need to be reported in the third patent application based on determining that the first references did not originate from the second patent application.

2. The method according to claim 1 wherein at least the first linkage is a non-familial, subject matter relationship between the first and second patent applications.

3. The method according to claim 1, further comprising assigning a non-zero hops value to at least one of the first references when the first references are reported in the second patent application, and wherein preventing the display of the at least one first references in the third patent application is based on the non-zero hops value.

4. The method according to claim 1, further comprising assigning a zero hops value to at least one of the first references when the first references are reported in the second patent application, and wherein the at least one of the first references is displayed as needing to be reported in the third patent application based on the zero hops value.

5. The method according to claim 1, wherein at least two of the first and second references include non-patent publications, and wherein identity between any two of the non-patent publications is determined based on comparison of character string identifiers formed based on the titles of the non-patent publications, wherein the string identifiers are formed by capitalizing all letters of the respective titles and removing all non-numeric identifiers from the respective titles.

6. The method according to claim 5, wherein the character string identifiers are further truncated to be no more than a predetermined length.

7. The method according to claim 1, wherein one of the first and second references originate from an office action associated with the respective first and second cases, the method further comprising creating the office action as a reportable reference in the database in response to the respective one of the first or second references being reported.

8. An apparatus comprising:
a processor; and
memory coupled to the processor, the memory including instructions operable by the processor to cause the apparatus to:
establish a first linkage in a database between first and second patent applications so that first references reported in the first patent application are indicated as needing to be reported in the second patent application when data related to the second patent application is accessed via the database;
establish a second linkage in the database between the second patent application and a third patent application so that references reported in the second patent application are indicated as needing to be reported in the third patent application, wherein there is no linkage in the database between the first patent application and the third patent application analogous to the first and second linkages;
detect via the database that the first references have been reported in the second patent application; and
prevent an indication that the first references as needs to be reported in the third patent application based on determining that the first references did not originate from the second patent application.

9. The apparatus according to claim 8 wherein at least the first linkage is a non-familial, subject matter relationship between the first and second patent applications.

10. The apparatus according to claim 8, wherein the processor further causes the apparatus to assign a non-zero hops value to at least one of the first references when the first references are reported in the second patent application, and wherein preventing the display of the at least one first references in the third patent application is based on the non-zero hops value.

11. The apparatus according to claim 8, wherein the processor further causes the apparatus to assign a zero hops value to at least one of the first references when the first references are reported in the second patent application, and wherein the at least one of the first references is displayed as needing to be reported in the third patent application based on the zero hops value.

12. The apparatus according to claim 8, wherein at least two of the first and second references include non-patent publications, and wherein identity between any two of the non-patent publications is determined based on comparison of character string identifiers formed based on the titles of the non-patent publications, wherein the string identifiers are formed by capitalizing all letters of the respective titles and removing all non-numeric identifiers from the respective titles.

13. The apparatus according to claim 12, wherein the character string identifiers are further truncated to be no more than a predetermined length.

14. The apparatus according to claim 8, wherein one of the first and second references originate from an office action associated with the respective first and second cases, and wherein the processor further causes the apparatus to create the office action as a reportable reference in the database in response to the respective one of the first or second references being reported.

15. An computer-readable storage medium having instructions stored thereon and capable of being executed by a processor to cause an apparatus to:
establish a first linkage in a database between first and second patent applications so that first references reported in the first patent application are indicated as needing to be reported in the second patent application when data related to the second patent application is accessed via the database;
establish a second linkage in the database between the second patent application and a third patent application so that references reported in the second patent application are indicated as needing to be reported in the third patent application, wherein there is no linkage in the database between the first patent application and the third patent application analogous to the first and second linkages;
detect via the database that the first references have been reported in the second patent application; and
prevent an indication that the first references as needs to be reported in the third patent application based on determining that the first references did not originate from the second patent application.

16. The computer-readable storage medium according to claim 15 wherein at least the first linkage is a non-familial, subject matter relationship between the first and second patent applications.

17. The computer-readable storage medium according to claim 15, wherein the instructions are further executable to cause the apparatus to assign a zero hops value to at least one of the first references when the first references are reported in the second patent application, and wherein the at least one of the first references is displayed as needing to be reported in the third patent application based on the zero hops value.

18. The computer-readable storage medium according to claim 15, wherein the instructions are further executable to cause the apparatus to assign a zero hops value to at least one of the first references when the first references are reported in the second patent application, and wherein the at least one of the first references is displayed as needing to be reported in the third patent application based on the zero hops value.

19. The computer-readable storage medium according to claim 15, wherein at least two of the first and second references include non-patent publications, and wherein identity between any two of the non-patent publications is determined based on comparison of character string identifiers formed based on the titles of the non-patent publications, wherein the string identifiers are formed by capitalizing all letters of the respective titles and removing all non-numeric identifiers from the respective titles.

20. The computer-readable storage medium according to claim 15, wherein one of the first and second references originate from an office action associated with the respective first and second cases, and wherein the instructions are further executable to cause the apparatus to create the office action as a reportable reference in the database in response to the respective one of the first or second references being reported.
